(19) United States
(12) Patent Application Publication
(10) Pub. No.: US 2020/0345037 A1
(43) Pub. Date: Nov. 5, 2020

(54) NEW FORMULATION

(71) Applicant: DSM IP ASSETS B.V., Heerlen (NL)

(72) Inventors: Andrea BULBARELLO, Kaiseraugst (CH); Karin LEUTHARDT, Kaiseraugst (CH); Thomas LINDEMANN, Kaiseraugst (CH); Wolf PELLETIER, Lampertheim (DE); Eleanor TREDWAY, Bardowick (DE)

(21) Appl. No.: 16/644,018

(22) PCT Filed: Aug. 16, 2018
(86) PCT No.: PCT/EP2018/072162

§ 371 Date: Mar. 3, 2020

(30) Foreign Application Priority Data
Aug. 25, 2017 (EP) 17187859.8

(51) Int. Cl. A23K 20/174; A23K 10/22; A23K 30/00; A23K 20/158; A23K 20/163

(52) U.S. Cl. CPC A23K 20/174; A23K 10/22; A23K 20/163; A23K 20/158; A23K 30/00

(57) ABSTRACT

The present invention relates to the use of a composition for stabilizing fish meal.

The present invention relates to finding a solution, which allows the stabilization of fish meal.

Fish meal, or fishmeal, is a commercial product, which is mostly made from fish, that are not generally used for human consumption. It is used primarily as a protein supplement in compound feed (especially for feeding farmed fish, pigs and poultry). Furthermore, there are other uses for fishmeal such as the use in fertilizers.

A small portion of the fishmeal is made from the bones and offal left over from processing fish used for human consumption, while the larger percentage is manufactured from wild-caught, small marine fish; either unmanaged by-catchor sometimes sustainable fish stocks. It is powder or cake obtained by drying the fish or fish trimmings, often after cooking, and then grinding it. If the fish used is a fatty fish it is first pressed to extract most of the fish oil.

Since sometimes the uses and the need of fishmeal is increasing due to the rising demand for fish, as people in the developed world turn away from red meat and toward other sources of meat protein.

Fishmeal is made by cooking, pressing, drying, and grinding of fish or fish waste to which no other matter has been added. It is a solid product from which most of the water is removed and some (or all) of the oil is removed. About four or five tonnes of fish are needed to manufacture one tonne of dry fishmeal.

Of the several ways of making fishmeal from raw fish, the simplest is to let the fish dry out in the sun. This method is still used in some parts of the world where processing plants are not available, but the end product is of poor quality in comparison with the ones made by modern methods.

Now, all industrial fish meal is usually made by the following process:

Cooking: A commercial cooker is a long, steam-jacketed cylinder through which the fish are moved by a screw conveyor. This is a critical stage in preparing the fishmeal, as in-complete cooking means the liquid from the fish cannot be pressed out satisfactorily and overcooking makes the material too soft for pressing. No drying occurs in the cooking stage.

Pressing: A perforated tube with increasing pressure is used for this process. This stage involves removing some of the oil and water from the material. The solid is known as press cake. The water content in pressing is reduced from 70% to about 50% and the oil content is reduced to 4%.

Drying: If the meal is under-dried, moulds or bacteria may grow. If it is over-dried, scorching may occur and this reduces the nutritional value of the meal.

The two main types of dryers are:

Direct: Very hot air at a temperature of about 500° C. is passed over the material as it is tumbled rapidly in a cylindrical drum. This is the quicker method, but heat damage is much more likely if the process is not carefully controlled. Indirect: A cylinder containing steam-heated discs is used, which also tumbles the meal.

Grinding: This last step in processing involves the breakdown of any lumps or particles of bones.

The fish meal has usually to be transported long distances by ship (or other vehicles) to the various locations, where it is used and needed.

Unmodified fish meal can spontaneously combust from heat, which is generated by oxidation of the polyunsaturated fatty acids in the meal.

In the past, factory ships have sunk because of such fires. Usually that danger has been eliminated by adding antioxidants to the fish meal.

It is very common to use ethoxyquin as an antioxidant. But nowadays there are some issues in connection with ethoxyquin.

Ethoxyquin has long been suggested to be a possible carcinogen, and a very closely related chemical, 1,2-dihydro-2,2,4-trimethylquinoline, has been shown to have carcinogenic activity in rats, and a potential for carcinogenic effect to fishmeal prior to storage or transportation.

Therefore, there is a need to replace ethoxyquin as an antioxidant.

The goal was to find a formulation which allows to stabilize the fish meal, and which is also easy produced, and which is easy to be used.

For that reason, the formulation should have some essential features:
Low viscosity
No toxicity
High concentration of vitamin E

We found that an emulsion comprising water, at least one specific emulsifier and vitamin E fulfils all the desired requirements.

Therefore, the present invention relates to the use of a composition comprising
(i) 2-50 wt-%, based on the total weight of the formulation, of vitamin E, and
(ii) 0.15-30 wt-%, based on the total weight of the formulation, of emulsifier, and
(iii) 40-70 wt-%, based on the total weight of the formulation, of water, for stabilizing fish meal.

The composition according to the present invention is free from ethoxyquin.

Furthemore, the present invention also relates to the use of a composition consisting of
(i) 2-50 wt-%, based on the total weight of the formulation, of vitamin E, and
(ii) 0.15-30 wt-%, based on the total weight of the formulation, of emulsifier, and
(iii) 40-70 wt-%, based on the total weight of the formulation, of water, for stabilizing fish meal.

The stabilization is usually achieved by spraying the composition on the fish meal (either before loading to the transporting vehicle or when loaded or as well as a combination thereof).

Vitamin E exists in eight different forms, four tocopherols and four tocotrienols. Vitamin E is commercially available from various suppliers.

Commercial vitamin E supplements can be classified into several distinct categories:

Fully synthetic vitamin E, “dl-alpha-tocopherol”, the most inexpensive, most commonly sold supplement form (usually sold as the acetate ester).

Semi-synthetic “natural source” vitamin E esters, the “natural source” forms used in tablets and multiple vitamins. These are highly fractionated d-alpha tocopherols or their esters, often made by synthetic methylation of gamma and beta d,d,d tocopherol vitamers extracted from plant oils.
Less fractionated “natural mixed tocopherols” and high d-gamma-tocopherol fraction supplements.

Synthetic vitamin E derived from petroleum products is manufactured as all-racemic alpha tocopheryl acetate with a mixture of eight stereoisomers. In this mixture, one alpha-to-copherol molecule in eight molecules are in the form of RRR-alpha-tocopherol (12.5% of the total).

The 8-isomer all-rac vitamin E is always marked on labels simply as dl-tocopherol or dl-tocopheryl acetate, even though it is (if fully written out) actually dl,dl,dl-tocopherol. The present largest manufacturers of this type are DSM and BASF.

Natural alpha-tocopherol is the RRR-alpha (or ddd-alpha) form. The synthetic dl,dl,dl-alpha (“dl-alpha”) form is not as active as the natural ddd-alpha (“d-alpha”) tocopherol form. This is mainly due to reduced vitamin activity of the 4 possible stereoisomers which are represented by the I or S enantiomer at the first stereocenter (an S or I configuration between the chromanol ring and the tail, i.e., the SRR, SRS, SSR, and SSS stereoisomers). The 3 unnatural “2R” stereoisomers with natural R configuration at this 2′ stereocenter, but S at one of the other centers in the tail (i.e., RSR, RRS, RSS), appear to retain substantial RRR vitamin activity, because they are recognized by the alpha-tocopherol transport protein, and thus maintained in the plasma, where the other four stereoisomers (SRR, SRS, SSR, and SSS) are not. Thus, the synthetic all-rac-α-tocopherol in theory would have approximately half the vitamin activity of RRR-alpha-tocopherol in humans. Experimentally, the ratio of activities of the 8 stereoisomer racemic mixture to the natural vitamin, is 1 to 1.36 in the rat pregnancy model (suggesting a measured activity ratio of 1/1.36=74% of natural, for the 8-isomer racemic mix).

Although it is clear that mixtures of stereoisomers are not as active as the natural RRR-alpha-tocopherol form, in the ratios discussed above, specific information on any side effects of the seven synthetic vitamin E stereoisomers is not readily available.

“Mixed tocopherols” in the US contain at least 20% w/w other natural R, R,R-tocopherols, i.e. R, R,R-alpha-tocopherol content plus at least 25% R, R,R-beta-, R, R,R-gamma-, R, R, R-delta-tocopherols.

Emulsifiers

Suitable emulsifiers for the formulation according to the present invention are modified polysaccharides.

The term “modified polysaccharide” as used in the present specification and claims refers to a polysaccharide which has been modified by known methods (chemically or physically, including enzymatic or thermal reactions) to be a good emulsifier in an oil in water context to emulsify the oil into a fine dispersion in the aqueous medium. Accordingly, the modified polysaccharide has been modified to have a chemical structure which provides it with a hydrophilic (affinity to water) portion and a lipophilic (affinity to dispersed phase) portion.

This enables it to dissolve in the dispersed oil phase and in the continuous water phase. Preferably the modified polysaccharide has a long hydrocarbon chain as part of its structure (preferably C5-18) and is capable of forming a stable emulsion of a desired average oil droplet size (for example 200-300 nm) under suitable emulsifying or homogenizing conditions. Such conditions encompass emulsification under normal pressure, e.g., by rotor stator treatment as well as high pressure homogenization, viz. under a pressure of about 750/50 psi/bar to about 14500/1000 psi/bar. High pressure in the range of about 1450/100 psi/bar to about 5800/400 psi/bar is preferred.

Modified polysaccharides are well known materials which are available commercially or which may be prepared by a skilled person using conventional methods.

A preferred modified polysaccharide is modified starch. Starches are hydrophilic and therefore do not have emulsifying capacities. However, modified starches are made from starches substituted by known chemical methods with hydrophobic moieties. For example starch may be treated with cyclic dicarboxylic acid anhydrides such as succinic anhydrides, substituted with a hydrocarbon chain (see Modified Starches: Properties and Uses, ed. O. B. Wurzburg, CRC Press, Inc., Boca Raton, Florida (1991)). A particularly preferred modified starch of this invention has the following structure (compound of formula (I):

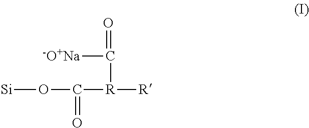

wherein St is a starch,

R is an alkylene group and R′ is a hydrophobic group.

Preferably the alkylene group is a lower alkylene group, such as dimethylene or trimethylene. R′ may be an alkyl or alkenyl group, preferably C₅ to C₅₀. A preferred compound of Formula I is starch sodium octenyl succinate. It is available commercially from, among other sources, Ingredion, as Capsul®.

Another group of suitable emulsifiers are lectithins.

Lecithin (from the Greek lekithos, “egg yolk”) is a generic term to designate any group of yellow-brownish fatty substances occurring in animal and plant tissues, which are amphiphilic—they attract both water and fatty substances (and so are both hydrophilic and lipophilic), and are used for smoothing food textures, dissolving powders (emulsifying), homogenizing liquid mixtures, and repelling sticking materials.

Lecithins are mixtures of glycerophospholipids including phosphatidylcholine, phosphatidylethanolamine, phosphatidylinositol, and phosphatidic acid.

If needed any other ingredient can be added to the composition according to present invention. That can be any for example a further antioxidant (of course no ethoxyquin).

An important feature of the present invention is that the viscosity of the formulation is never larger than 100 cP.

Dynamic viscosity was measured at 20° C. by employing a Brookfield DV-II Viscometer equipped with a type 18 splinter and a rotor speed of 12. The determination was repeated 5 times and the results accepted only when the RSD (Relative Standard Deviation) was equal or below a value of 3%. All values of the viscosity in the present patent application are measured by this method, when not otherwise mentioned.

The droplet size of the oil in the formulation was also measured.

The average droplets size distribution was measured by employing a Malvern Masterizer 2000.

The general procedure to determine the average droplets size distribution 3 drops of emulsion samples are carefully dispersed into 20 mL of demineralized water previously heated up to 50° C. Subsequently, the previously prepared diluted dispersion is poured into the Hydro 2000S(A) dispersion unit operating at 25° C.

The particle size distribution is then derived by following the Mie-Theory model, applying the following parameters:

Analytic Model: Spherical

Particle Abs.: 0.001

Particle RI: 1.468

Obscuration: 3-6%

Dispersant: Demineralized water at 25° C.

Dispersant RI: 1.33

Results are then expressed as average droplets diameter (surface) D[3.2].

The composition according to the present invention is then used to stabilize fish meal. That can be done according to the methods which are used already. Usually the composition is spray onto the fish meal when it is in a container (or any other used transport or storage mean).

The formulation can be sprayed to the fish meat before and/or during the transport.

The following examples serve to illustrate specific embodiments of the invention claimed herein. All percentages are given in relation to the weight and all the temperatures are given in degree Celsius.

### EXAMPLES

### Example 1

Composition:

| | |
|---|---|
| 200 g | Demineralized (or Tap Water) |
| 169 g | Modified Food Starch |
| 177 g | dl-α-Tocopherol |

All the ingredients listed are precisely weighted by the use of a calibrated scale.

Subsequently the water in placed in a stainless-steel vessel and heated up to 65° C. When the target water temperature is reached, modified food starch is poured into the water while mechanical stirring is occurring (1200 rpm).

The stirring operation (modified food starch+water) is performed for one hour (always at a temperature of 65° C.).

Meanwhile the modified food starch is getting properly dissolved into water, the dl-α-Tocopherol is warmed-up to 65° C. by employing a heated plate (under magnetic stirring conditions).

Subsequently the mechanical stirrer speed is increased to 5500 rpm and the warm tocopherol oil is poured slowly into the water/modified food starch solution.

After having poured the whole dl-a-Tocopherol fraction, the dispersion is let emulsified for 10 additional minutes (always at 65° C.).

After this step, 200 g of demineralized water (at 60° C. is added) are added and the whole dispersion is cooled down slowly by keeping it under mechanical stirring conditions (400 rpm).

After the above described procedure, an aliquot of the obtained dispersion (600 g) is taken and further diluted with an addition of 100 g of demineralized water in order to reach a dynamic viscosity below 70 cP and a dl-α-Tocopherol concentration of approximately 20% (w/w)

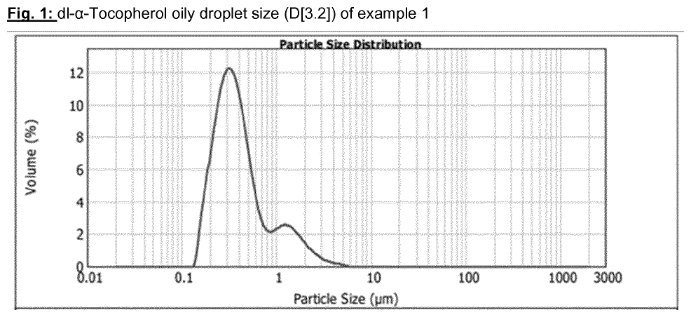

In order, then to evaluate the dl-α-Tocopherol oily droplet size the obtained dispersion is analyzed by the use of a Malver Mastersizer 2000 (the obtained results are shown on FIG. 1.)

### Example 2

Composition:

| | |
|---|---|
| 190 g | Demineralized (or Tap Water) |
| 10 g | Ethanol (70%) |
| 2 g | Sunflower Lecithin |
| 177 g | dl-a-Tocopherol |

All the ingredients listed are precisely weighted by the use of a calibrated scale.

Subsequently the water in placed in a stainless-steel vessel and heated up to 65° C.

When the target water temperature is reached, sunflower lecithin and ethanol are poured into the water while mechanical stirring is occurring (1200 rpm).

The stirring operation (lecithin+water+ethanol) is performed for one hour (always at a temperature of 65° C.).

Meanwhile the lecithin is getting properly dissolved into water, the dl-α-Tocopherol is warmed-up to 65° C. by employing a heated plate (under magnetic stirring conditions). Subsequently the mechanical stirrer speed is increased to 5500 rpm and the warm tocopherol oil is poured slowly into the water/modified food starch solution.

After having poured the whole dl-α-Tocopherol fraction, the dispersion is let emulsified for 10 additional minutes (always at 65° C.), during this step a pre-emulsion is formed. After, the previously pre-emulsion is processed through a High-Pressure-Homogenizer for achieving further stabilization.

Subsequently, 200 g of demineralized water (at 60° C. is added) are added into the homogenized emulsion and the whole mixture is cooled down slowly by keeping it under mechanical stirring conditions (400 rpm).

After the above described procedure, an aliquot of the obtained dispersion (600 g) is taken and further diluted with an addition of 100 g of demineralized water in order to reach a dynamic viscosity below 70 cP and a dl-α-Tocopherol concentration of approximately 20% (w/w)

In order, then to evaluate the dl-α-Tocopherol oily droplet size the obtained dispersion is analyzed by the use of a Malver Mastersizer 2000.

### Example 3

Composition:

| | |
|---|---|
| 200 g | Demineralized (or Tap Water) |
| 169 g | Modified Food Starch |
| 177 g | dl-a-Tocopherol |
| 50 g | Ascorbyl Palmitate |
| 25 g | Sodium Ascorbate |

All the ingredients listed are precisely weighted by the use of a calibrated scale.

Subsequently the water is placed in a stainless-steel vessel and heated up to 65° C.

When the target water temperature is reached, modified food starch and sodium ascorbate are poured into the water while mechanical stirring is occurring (1200 rpm).

The stirring operation (modified food starch+water) is performed for one hour (always at a temperature of 65° C.).

Meanwhile the modified food starch is getting properly dissolved into water, the dl-α-Tocopherol is warmed-up to 90° C. by employing a heated plate (under magnetic stirring conditions). When the desired temperature is reached the ascorbyl palmitate is added and let properly be dispersed for about 15 minutes.

Subsequently the mechanical stirrer speed (stirring the water phase) is increased to 5500 rpm and the warm tocopherol/ascorbyl palimtate oil is poured slowly into the water/modified food starch/sodium ascorbate solution.

After having poured the whole dl-α-Tocopherol fraction, the dispersion is let emulsified for 10 additional minutes (always at 65° C.).

After this step, 200 g of demineralized water (at 60° C. is added) are added and the whole dispersion is cooled down slowly by keeping it under mechanical stirring conditions (400 rpm).

After the above described procedure, an aliquot of the obtained dispersion (600 g) is taken and further diluted with an addition of 100 g of demineralized water in order to reach a dynamic viscosity below 70 cP and a dl-α-Tocopherol concentration of approximately 20% (w/w)

In order, then to evaluate the dl-α-Tocopherol oily droplet size the obtained dispersion is analyzed by the use of a Malver Mastersizer 2000.

### Example 4

Composition:

| | |
|---|---|
| 95 g | Demineralized (or Tap Water) |
| 5 g | Ethanol (70%) |
| 2 g | Soy Lecithin |
| 1 g | dl-a-Tocopherol |

All the ingredients listed are precisely weighted by the use of a calibrated scale.

Subsequently the water in placed in a stainless-steel vessel and heated up to 65° C.

When the target water temperature is reached, soy lecithin and ethanol are poured into the water while mechanical stirring is occurring (1200 rpm).

The stirring operation (lecithin+water+ethanol) is performed for one hour (always at a temperature of 65° C.).

Meanwhile the lecithin is getting properly dissolved into water, the dl-α-Tocopherol is warmed-up to 65° C. by employing a heated plate (under magnetic stirring conditions). Subsequently the mechanical stirrer speed is increased to 5500 rpm and the warm tocopherol oil is poured slowly into the water/modified food starch solution.

After having poured the whole dl-α-Tocopherol fraction, the dispersion is let emulsified for 10 additional minutes (always at 65° C.), during this step a pre-emulsion is formed.

In order, then to evaluate the dl-α-Tocopherol oily droplet size the obtained dispersion is analyzed by the use of a Malver Mastersizer 2000.

1. A method for stabilizing fish meal which comprises incorporating into fish meal a stabilizing effective amount of a composition comprising:
(i) 2-50 wt-%, based on the total weight of the formulation, of vitamin E, and
(ii) 0.15-30 wt-%, based on the total weight of the formulation, of at least one emulsifier, and
(iii) 40-70 wt-%, based on the total weight of the formulation, of water.

2. The method according to claim 1, wherein vitamin E is d dl-α-tocopherol.

3. The method according to claim 1, wherein composition is free of ethoxyquin.

4. The method according to claim 1, wherein the at least one emulsifier is chosen from the groups consisting of modified polysaccharides and lecithins.

5. The method according to claim 4, wherein modified polysaccharide is modified starch.

6. The method according to claim 1, wherein the composition comprises further ingredients.

7. The method according to claim 6, wherein the composition comprises ascorbyl palmitate and/or sodium ascorbate.

8. The method according to claim 1, wherein formulation has a viscosity of less than 100 cP.
